(19) United States
(12) Patent Application Publication
(10) Pub. No.: US 2018/0317452 A1
(43) Pub. Date: Nov. 8, 2018

(54) DOG GARMENT THAT RESTRICTS SCRATCHING AND BITING

(71) Applicants: Carrie Richardson, Ventura, CA (US); Tom Richardson, Ventura, CA (US)

(72) Inventors: Carrie Richardson, Ventura, CA (US); Tom Richardson, Ventura, CA (US)

(21) Appl. No.: 16/020,898

(22) Filed: Jun. 27, 2018

Related U.S. Application Data
(63) Continuation-in-part of application No. 15/885,145, filed on Jan. 31, 2018.
(60) Provisional application No. 62/452,654, filed on Jan. 31, 2017.

(51) Int. Cl. A01K 13/00

(52) U.S. Cl. CPC A01K 13/006

(57) ABSTRACT

A shield-like garment to be worn by dogs. The garment includes a durable water-resistant fabric cover that fits snugly on the back of the dog with straps that pass under the torso holding it in place. Due to the stiffness of the garment, the dog finds it very difficult if not impossible to bend and scratch areas that may be itching. The garment may have a fabric outer cover which presents relatively soft surfaces against the dog and a stiff plastic insert that extends up the length of the shield. The garment is sized to extend from the dog's tail to just behind the dog's neck for maximum resistance to the dog bending around.

### RELATED APPLICATIONS

The present application is a continuation-in-part of co-pending U.S. patent application Ser. No. 15/855,145, filed Jan. 31, 2018, which claims priority under 35 U.S.C. 119 to U.S. Provisional Application Ser. No. 62/452,654, filed Jan. 31, 2017, the contents of which are expressly incorporated herein by reference.

### FIELD OF INVENTION

The pet guardian shield is a garment to be worn by dogs that inhibits itching with their nails and biting with their teeth and mouth.

### BACKGROUND OF THE INVENTION

Pets often develop itching from allergies, fleas and other skin conditions that cause them to scratch incessantly, sometime resulting in skin lesions and even infection. Cones worn over the head are used, but they are unsightly, the dog can often wiggle out of them and they otherwise cause discomfort. There is a need for an alternative to dog cones.

### SUMMARY OF THE INVENTION

The pet guardian shield is a garment to be worn by dogs. It is a dog cone alternative worn on the back of the dog that has a durable water-resistant Nylon cover and a stiff insert. The garment fits on the back of the dog with straps that pass under the torso holding it snugly in place. Due to the stiffness of the shield garment, the dog finds it very difficult if not impossible to bend and scratch areas that may be itching. For instance, sitting and bending around to lick or bite at the dog's belly or underside is nearly impossible. In a preferred embodiment, the garment includes a fabric outer cover which presents relatively soft surfaces against the dog and a stiff insert that extends up the length of the shield. The garment is sized to extend from the dog's tail to just behind the dog's neck for maximum resistance to the dog bending around.

The shape of the pet guardian shield garment is a trapezoid with an upper and lower shell panels and pocket in between. The pet garment is made to be lightweight with a Velcro resealable opening at the bottom separating the upper and lower shell and permitting introduction and removal of a stiff protective core insert.

The pet garment is and can work as a healing and protective covering that can inhibit the dog from chewing the back side, tail and under belly along with the back end of the dog. Dogs can eat, drink, and play with the pet guardian shield on. It makes the lives of both the owner and the dog better in the time of healing and recovering with the pet guardian shield on.

The pet guardian shield will help prevent the dog from itching the sides or biting the tail-end, thus allowing wounds or skin-irritations to heal.

### BRIEF DESCRIPTION OF THE DRAWINGS

FIG. 1 is a view of the pet guardian shield garment as worn by a dog looking from the rear;

FIG. 2 is a side view of the pet guardian shield garment on a dog as viewed from the side;

FIG. 3 is a top plan view of the pet guardian shield garment isolated;

FIG. 4 is a layout view of the pet guardian shield garment;

FIG. 5 is a layout view of an alternative pet guardian shield garment; and

FIG. 6 is a side view of the garment of FIG. 5.

### DETAILED DESCRIPTION

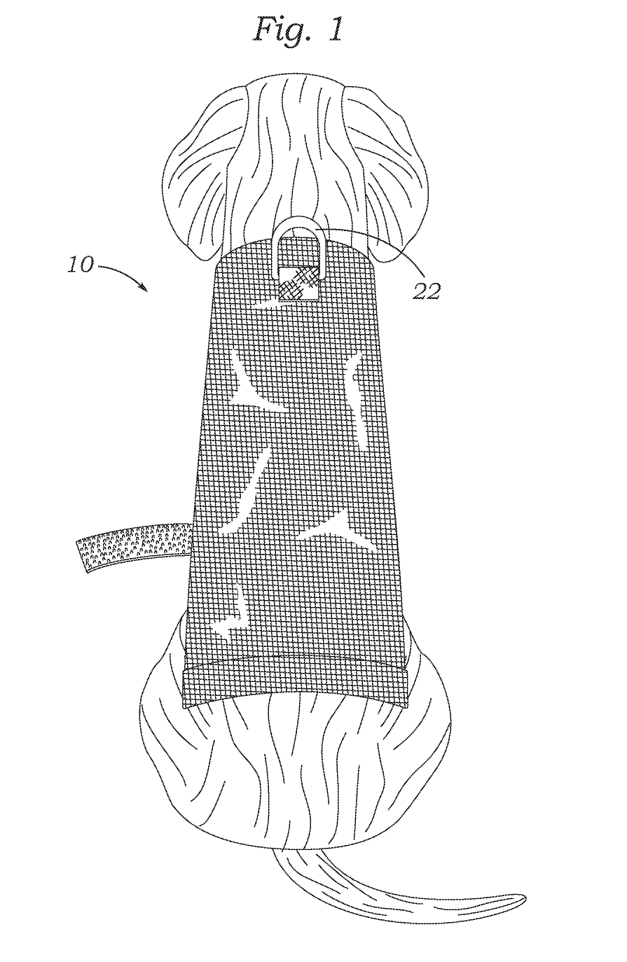

FIGS. 1 & 2 are views of the pet guardian shield garment 10 as worn by a dog from the rear and side. The pet garment 10 is preferably made of Nylon and has a flexible plastic core insert. Velcro straps are attached on the front of the shoulders and another under the dog's belly in the middle of the dog. The pet garment 10 covers from neck to tail and sides also.

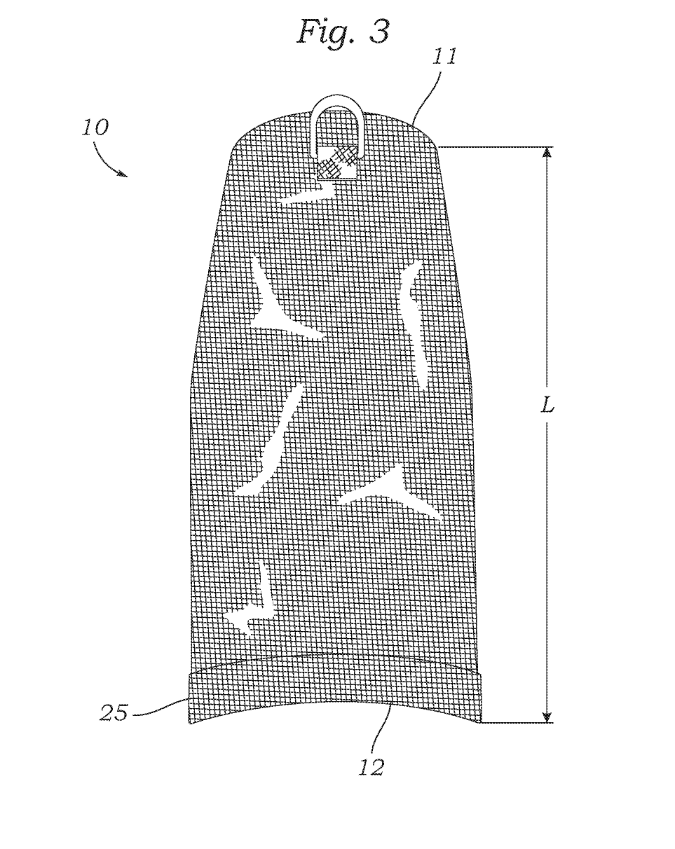

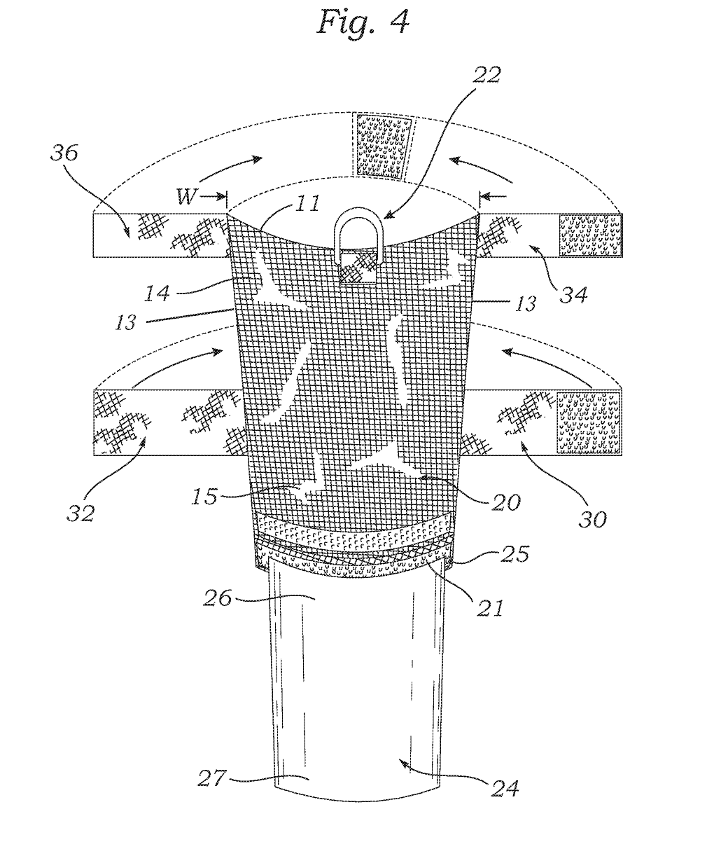

With reference also to the top plan view of the garment in FIG. 3 and the layout view of FIG. 4, the pet garment 10 extends in a longitudinal direction between an upper end 11 and a lower end 12. A shorter lateral dimension exists between side edges 13.

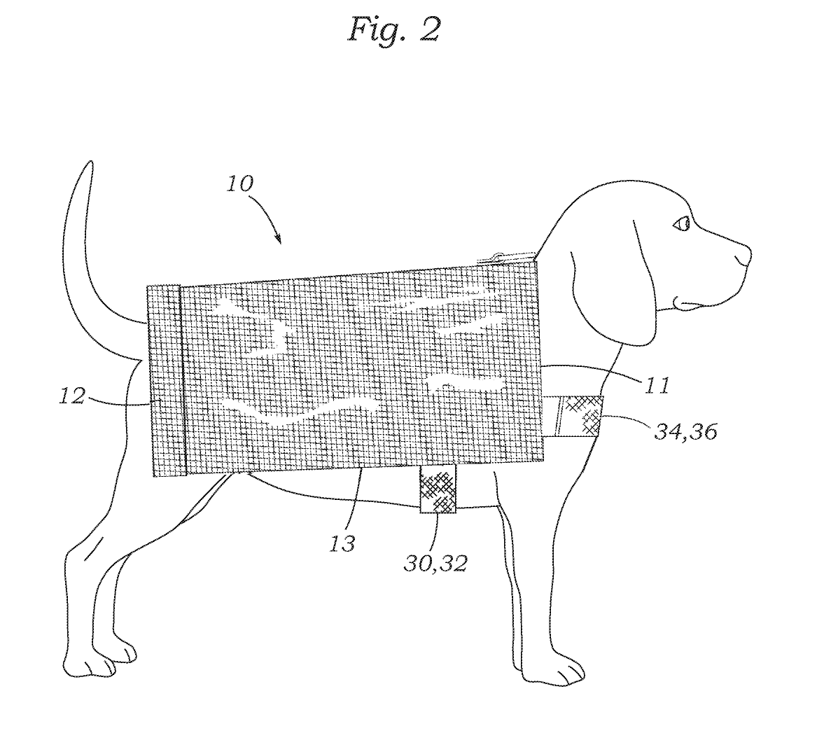

As seen in FIG. 2, the pet garment 10 has a length sized to be worn on a dog's backside such that the upper end 11 is adjacent the dog's neck and the lower end 12 terminates adjacent the dog's tail. The pet garment 10 also has a width sufficient to wrap around the dog's torso such that opposite side edges 13 extend down to a location adjacent the dog's chest.

FIG. 4 is a layout view of the pet garment 10, and shows that the side edges 13 in an upper portion 14 adjacent the upper end 11 flare outward relative to the side edges in a lower portion 15. This lateral widening in the upper portion 14 generally defines a trapezoid which helps the pet garment 10 wrap around the shoulders and ribcage of the dog. Both the upper end 11 and lower end 12 may be curved so that when bent around the dog, the ends conform to the general shape of the dog at the neck and backside. Specifically, the upper end 11 may be concave and the lower end 12 may be convex.

As seen in FIG. 4, the pet garment 10 is made with a durable water-resistant fabric outer shell or cover 20 (e.g., Nylon) that inhibits the dog from itching with their nails and biting with their teeth and mouth. The cover 20 desirably has a shape of a trapezoid as mentioned to provide full cover of the back of the dog from the neck to the tail base. The cover 20 has an opening 21 at the back of the garment that works as an entrance to a pocket that opens to receive a stiff plastic core insert. The inner pocket is formed between two juxtaposed layers or panels of fabric that form the cover 20. The opening 21 has resealable mating hook and loop (i.e., Velcro) fastening strips including on a flap 25 to close the plastic core securely in the garment 20. The panels and pocket opening 21 and flap 25, along with attachment of the Velcro strips, may all be formed with traditional textile techniques such as sewing, heat sealing, rivets, etc. A preferred fabric is Nylon, though other synthetic fabrics such as polyethylene, Lycra, Rayon and the like may be used, as well as natural textiles such as cotton, denim, burlap, etc.

The pet garment 10 also has a leash loop 22 on the backside near to the upper end 11 to which to attach a dog leash.

The re-sealable Velcro opening 21 aligned along the lower end 12 enables insertion and removal of a stiff core insert 24 between the layers of fabric of the cover. The Velcro enables closure of the opening 21 to retain the plastic core securely within the garment 10. Of course, other closure structure may be used, such as a zipper, snaps, buttons, etc., though the Velcro flap 25 is considered superior for ease of use and to enable washing of the entire cover 20. The insert 24 is a plastic sheet that is thin and flexible that can come out of the covering 24 so the fabric cover can be washed. In one embodiment, the insert 24 is made of high density polyethylene (HDPE) sheet with a thickness of between about 3-7 mil (0.003-0.007″). Some other plastics such as high impact polyethylene may be too brittle given that the dog will inevitably stress or cause impact to the insert 24 in play.

The plastic insert 24 desirably has a trapezoid shape with a wider upper end 26 and a narrower lower end 27 so as to fit closely within the trapezoidal cover 20. Although the upper end 26 is slightly wider than the opening 21, the inherent flexibility of both the cover 20 and the insert 24 enables the opening to be spread apart while the insert 24 is bent into a curve so as to fit therethrough. Once inside the pocket formed by the cover layers, the insert 24 can flatten out to fill the pocket to its corners.

The outer cover 20 has mating strap pairs extending from opposite side edges 13, including a lower pair 30, 32 being located between the upper and lower ends 11, 12 and closer to the lower end, and an upper pair 34, 36 being located adjacent the upper end 11. Specifically, a first lower strap 30 on the back right side of the cover 20 attaches in a midpoint of the right side edge 13 but closer to the lower end 12 and is movable to attach to a complementary second lower strap 32 on the left back side of the cover 20 at the same longitudinal position. A first upper strap 34 attaches to the right side edge 13 and a second upper strap 36 attaches to the left side edge 13, both adjacent to the upper end 11. When brought together, the first and second lower straps 30, 32 will attach underneath to the underside of the dog and may be secured together with Velcro or other fastener (snap, buckle, etc.).

The two lower straps 30, 32 wrap around to the underside of the dog as seen in FIG. 2 and fasten under the dog's torso between the front and rear legs, while the two upper straps 34, 36 wrap around the dog's chest in front of the front legs. Preferably, the lower straps 30, 32 are wider than the upper straps 34, 36 for the dog's comfort to avoid abrasion to the often hairless belly or chest from too thin of a strap.

A first upper strap 34 on the back right side of the cover 20 attaches at the upper end 11 and is movable to attach to a complementary second upper strap 36 on the left back side of the cover 20 at the same longitudinal position. When brought together, the first and second upper straps 34, 36 will attach underneath to the underside of the dog and may be secured together with Velcro or other fastener (snap, buckle, etc.). The two straps 34, 36 are wrapped around to the underside of the dog as seen in FIG. 2 and also fasten under the dog's chest.

The pet garment 10 is designed to inhibit the dog from itching and scratching the back of the shoulder with their back legs and nails. Due to the size of the garment 20 and the unique placement of the straps 30, 32, 34, 36 and the stiff plastic core insert 24, the pet garment 10 stops the dog from turning from front to back. The straps 30, 32 and 34, 36 are adjustable such that the garment 10 may be snugly/tightly attached to the dog's backside, providing a stiff jacket of sorts that prevents lateral bending of the dog's torso, which greatly inhibits the ability to bend and itch with the mouth or paws.

More specifically, with respect to FIG. 2, the garment 20 is bent and held in an arc over the back of the dog, extending down around the sides of the dog, and due to the stiff plastic core insert 24 is extremely stiff in bending about vertical axes. That is, the stiffness of the garment 20 when bent into an arc prevents the dog from rotating its head and neck area with respect to the rest of its body about vertical axes. The straps 30, 32 and 34, 36 are positioned such that the upper end 11 is close behind the dog's neck, as seen in FIG. 2, which presents an impediment to the dog turning its neck to scratch or bite. By securing the straps 30, 32 and 34, 36 firmly around the dog as shown the stiffness of the garment 20 makes it very difficult if not impossible for the dog to bend and scratch areas that may be itching.

With reference to the layout of FIGS. 3 & 4, the cover 20 has exemplary length L and width W dimensions. The width dimension is measured at the upper end 11, and it will be understood that the side edges 13 narrow toward the lower end 12. The specific angle of the trapezoid formed by the flat cover 20 may vary, but is desirably formed by the side edges 13 being angled between about 5-20° relative to each other. Of course, the side edges 13 may be other than linear, such as gently curved so as to be slightly convex or concave, or other irregular curvature, though the upper end 11 is always wider than the lower end 12.

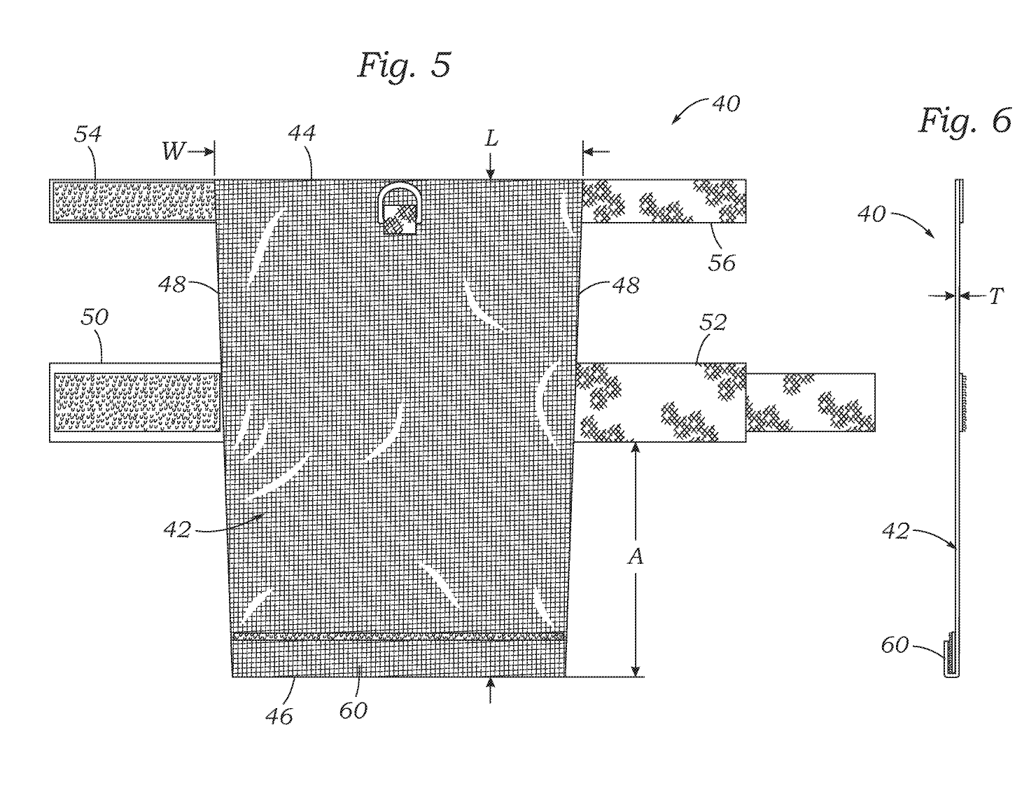

FIG. 5 is a layout view of an alternative pet guardian shield garment 40, and FIG. 6 is a side view of the flat garment. In this embodiment, the garment 40 has an outer fabric cover 42 enclosing a stiff but bendable insert (not shown), and straight top and bottom ends 44, 46, and straight but angled side edges 48. As before, the top end 44 is wider than the bottom end 46 such that the outer cover 42 is trapezoidal.

Also as before, the garment 40 has a lower pair of straps 50, 52 located between the upper and lower ends 44, 46 and closer to the lower end, and an upper pair 54, 56 located adjacent the upper end 44. Length L and width W dimensions are also shown, as well as a longitudinal dimension A that indicates the distance from the lower pair of straps 50, 52 to the lower end 46. In a preferred embodiment, the dimension A is between about 40-50% of the overall length L. As before, each strap 50, 52, 54, 56 has hook and loop fasteners at least along a distal length that couples with mating fasteners on the complementary strap. Alternatively, as mentioned, the fasteners may be buckles, rings, snaps, etc.

As with the earlier-described garment 20, the cover 42 has a flap 60 along the lower end 46 which may be secured to the cover material so as to enclose an opening and inner pocket for holding the stiff insert. Preferably the flap 60 has hook and loop fasteners along its length that couples with mating fasteners along the edge of the opening, though other closure solutions are contemplated. FIG. 6 shows the small thickness T of the cover 42, which in a preferred embodiment is between about 3-7 mil (0.003-0.007″), the thickness of the insert, plus the thickness of two layers of fabric that form the pocket. For instance, the thickness T may be between about 5-11 mil (0.005-0.011″). Of course, thicker or padded covers 42 may be desirably such as in cold climates to further provide some warmth to the pet along with the beneficial stiffness.

In exemplary embodiments, length L and width W dimensions for garments 10, 40 adapted for different sizes of dogs are provided below in Table I:

TABLE I
Exemplary cover 20 dimensions in inches

| Dog size | Cover length L | Cover width W |
|---|---|---|
| X Small | 10 | 8 |
| Small | 13 | 10 |
| Medium | 13 | 12 |
| Large | 14 | 13 |
| X Large | 20 | 19 |
| XX Large | 25 | 22 |

The pet garment 10, 40 when fitted properly, will cover the dog from the neck of the dog to the base of the tail and will extend down around the sides of the dog. The pet garment 10, 40 when used properly, creates a stiff surface making it difficult for the canine to turn and chew or bite the tail and rear legs of the dog, and will make it difficult for the dog to bring the rear legs to the front of their body—ears, neck, and chest.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. A pet garment for preventing dogs from itching, biting, or scratching irritated skin or injuries, comprising:
a. a fabric outer cover having a length sized to be worn on a dog's backside such that a upper end is adjacent the dog's neck and a lower end terminates adjacent the dog's tail, the outer cover having a width sufficient to wrap around the dog's torso such that opposite side edges extend down to a location adjacent the dog's chest, wherein panels of the cover form an inner pocket sized just smaller than outer dimensions of the cover;
b. a stiff core insert that fits closely within the pocket and hinders the ability of the dog to bend its body; and
c. mating strap pairs extending from opposite side edges, an upper pair of straps being located adjacent the upper end and a lower pair of straps being located between the upper and lower ends and closer to the lower end, each strap pair having an adjustable fastener to enable fastening the pairs below the dog's torso.

2. The garment of claim 1, wherein the fabric outer cover is made of a synthetic fabric and is washable upon removing the core insert.

3. The garment of claim 2, wherein the synthetic fabric is Nylon.

4. The garment of claim 1, wherein the core insert is formed of a stiff plastic sheet and the outer cover defines an opening adjacent the lower end through which the core insert may be inserted into the pocket.

5. The garment of claim 4, wherein the outer cover has a generally trapezoidal shape with the upper end being wider than the lower end, and the core insert has the same shape but smaller to fit within the pocket.

6. The garment of claim 5, wherein the generally trapezoidal shape is formed by the side edges being angled between about 5-20° relative to each other.

7. The garment of claim 4, wherein the stiff plastic sheet is formed of high density polyethylene (HDPE) sheet with a thickness of between about 3-7 mil (0.003-0.007″).

8. The garment of claim 4, wherein the outer cover includes a flap and mating hook and loop fastening strips at the opening to hold the core insert in the pocket.

9. The garment of claim 1, further including a leash loop attached to an outer panel of the outer cover adjacent the upper end.

10. The garment of claim 1, wherein the upper and lower pair of straps are spaced apart longitudinally so that the upper pair of straps is located in front of the front legs and the lower pair of straps is located between the front and rear legs.

11. The garment of claim 10, wherein each of the lower pair of straps is wider than each of the upper pair of straps.

12. The garment of claim 1, wherein the upper end is concave and the lower end is convex when the garment is laid flat.
